(19) United States
(12) Patent Application Publication
(10) Pub. No.: US 2008/0212823 A1
(43) Pub. Date: Sep. 4, 2008

(54) Loudspeaker and Assembly of Loudspeakers

(75) Inventor: Philip Derek Eduard De Haan, Hoorn (NL)

Correspondence Address: MYERS DAWES ANDRAS & SHERMAN, LLP, 19900 MACARTHUR BLVD., SUITE 1150, IRVINE, CA, 92612, US

(73) Assignee: ALCONS AUDIO B.V., Amsterdam (NL)

(21) Appl. No.: 11/587,834

(22) PCT Filed: Apr. 25, 2005
(86) PCT No.: PCT/NL2005/000306

§ 371 Date: Nov. 21, 2007

(30) Foreign Application Priority Data
Apr. 26, 2004 (NL) 1026038

(51) Int. Cl. H04R 11/02; H04R 25/00

(52) U.S. Cl. 381/412; 381/182

(57) ABSTRACT

A loudspeaker comprising a magnet unit that generates a magnetic field and a membrane which is mounted in a frame and which is provided with an electrical conductor arranged in a pattern on the membrane, which membrane is positioned in the magnetic field in such a manner that a force is exerted when current is fed through the conductor pattern on the membrane, which force is capable of setting the membrane vibrating to produce sound, said loudspeaker being provided with a sound opening located between the vibrating region and the outer side of the loudspeaker, which sound opening connects to a sound horn having diverging walls, characterized in that substantially identical sound openings and sound horns connecting thereto extend on both sides of the membrane.

### TECHNICAL FIELD

The invention relates to a loudspeaker comprising a magnet unit that generates a magnetic field and a membrane which is mounted in a frame and which is provided with an electrical conductor arranged in a pattern on the membrane, which membrane is positioned in the magnetic field in such a manner that a force is exerted when current is fed through the conductor pattern on the membrane, which force is capable of setting the membrane vibrating to produce sound, said loudspeaker being provided with a sound opening located between the vibrating region and the outer side of the loudspeaker, which sound opening connects to a sound horn having diverging walls.

Such a loudspeaker is disclosed in International patent application PCT/NL2004/00159 (not published).

### PRIOR ART

The invention is in particular aimed at providing an improved loudspeaker for applications in which a directed, narrow, elongate sound range is desired. Think in this connection of railway station platforms, for example, both in the open air and indoors, or underground, such as in underground stations. The sound horns of the loudspeakers may be directed in the longitudinal direction of the platform in order to direct the sound as much as possible at the location where travellers are waiting.

Two major problems occur with these loudspeakers. In general, a sound horn only suppresses sound in lateral direction to a limited degree. As a result, sound will nevertheless permeate in lateral direction, and thus into the environment, on open-air platforms. In particular in an urban environment this causes nuisance for the people living in the neighbourhood. In addition, it leads to unnecessary energy consumption, because the sound does not reach its intended destination, viz. the waiting public. On indoor platforms or in underground stations, the sound that has permeated in lateral direction reflects from the walls, which leads to a great deal of reverberation, making it difficult to catch what is being said. Furthermore, the aiming effect of the horns is limited to a restricted frequency range.

The invention is not limited to the above applications, however, and can be used advantageously, for example, in any application in which the listener is removed relatively far from the loudspeaker in comparison with nearby surfaces such as a wall, a ceiling or a floor, which can reflect sound, or in comparison with nearby areas where the presence of sound is undesirable.

The object of the invention is to provide a loudspeaker of the kind referred to in the introduction which, in particular in applications which aim at realising an elongate or a very specific range, diminishes the above-described effects in a simple and efficient manner and/or which exhibits better acoustic characteristics than the known loudspeakers.

### DESCRIPTION OF THE INVENTION

In a loudspeaker according to the invention, substantially identical sound channels and sound horns connected to said channels extend on either side of the membrane. Not only is sound emitted in two directions in a very efficient manner in this way, but in addition sound that permeates to the sides dies out entirely or partially as a result of the fact that the permeating sound waves emanating from the two sound horns are automatically in counter phase as a result of this construction. In this way a very well-directed and energy-efficient sound reproduction is achieved for a large frequency range. This may be advantageous for alarm loudspeakers as well, because such loudspeakers are frequently powered by batteries or by an emergency power unit, and because of said energy efficiency such power sources can be designed to be as small and thus as inexpensive as possible.

US patent application US-A-2004/0,047,488 discloses a loudspeaker comprising identical sound channels that extend on either side of the membrane. The sound that is emitted at the rear side of the membrane is eventually aimed at the front side via reflection. Said loudspeaker is not suitable for applications in which the goal is to achieve a highly controlled aiming effect, therefore, and consequently the loudspeaker does not have a sound horn.

Preferably, the loudspeaker is a magnetostatic ribbon loudspeaker whose membrane is a flat membrane in which the conductor pattern is integrated, with the sound openings being formed by sound channels. The invention can also be used with electrostatic loudspeakers, for example, and can be advantageous even with dome and cone loudspeakers.

Preferably, the sound horns have an elongate, e.g. rectangular or oval cross-section, making it possible to direct the sound separately in horizontal and in vertical direction. Preferably, the central axes of the sound horns, which are located between the upper wall and the lower wall, extend at an acute angle with respect to the membrane. For example, the central axes extend downwards at an angle with respect to the membrane, so that the sound is quite audible also directly below the loudspeaker and the sound need not be directed over the heads of the public.

Preferably, the central axes of the two sound channels of the loudspeaker, which are located between the outer wall and the inner wall of each channel, incline towards each other over a particular distance from the membrane. The term central axis of a sound channel is understood to mean the imaginary centre plane that lies precisely between the inner wall and the outer wall of the channel. In this way the wavefronts of the two sound sources are gradually directed towards each other and combined upon exiting the sound channels. The aforesaid lobing effect is thus largely prevented. Preferably, the outer walls of the two sound channels that are spaced furthest apart incline towards each other over a particular distance from the membrane and, likewise preferably, the inner walls of the two sound channels that lie closest together likewise incline towards each other over at least a particular distance from the membrane. Even more preferably, the inner and outer walls of each sound channel extend substantially parallel to each other.

The distance over which the walls incline towards each other is preferably at least 0.5 times, preferably at least 1 time the width of the sound channels. Furthermore, the spacing between the inner walls of the sound channels on the outer side of the housing is preferably less than 0.5 times, preferably less than 0.2 times the spacing between the inner walls on the side of the membrane. In this way the two wavefronts are combined in the most gradual way that is possible.

Preferably, the outer walls of the sound channels join the walls of a sound horn comprising diverging walls near their ends, as a result of which the combined way front initially widens in a controlled and moreover directed manner.

The invention further relates to an assembly of loudspeakers, wherein a number of loudspeakers are arranged in substantially aligned relationship, wherein the sound horns of two adjacent loudspeakers are directed substantially towards each other, and wherein the facing surfaces of the membranes of two adjacent loudspeakers are in phase (with the two surfaces simultaneously moving towards the listener and away from the listener, therefore). Preferably, the central axes of two sound ports that face towards each other are directed at a point located approximately at ear level precisely between the two loudspeakers. The aiming effect can be influenced by varying the position of the horns with respect to each other, e.g. directly opposite each other or inclined further towards each other on one side, and also the shape of the horn.

### BRIEF DESCRIPTION OF THE DRAWINGS

The invention will now be explained in more detail by means of a description of embodiments that are shown in the Figures, in which:

FIG. 1 is a partial perspective view of a loudspeaker;

FIG. 2 is a cross-sectional view of the loudspeaker of FIG. 1;

FIG. 3 is a cross-sectional view of the loudspeaker of FIG. 1, on which a sound horn is mounted;

FIG. 4 is a perspective view of a membrane unit; and

FIG. 5 is a cross-sectional view of a loudspeaker on which a sound horn is mounted on two sides.

### EMBODIMENTS OF THE INVENTION

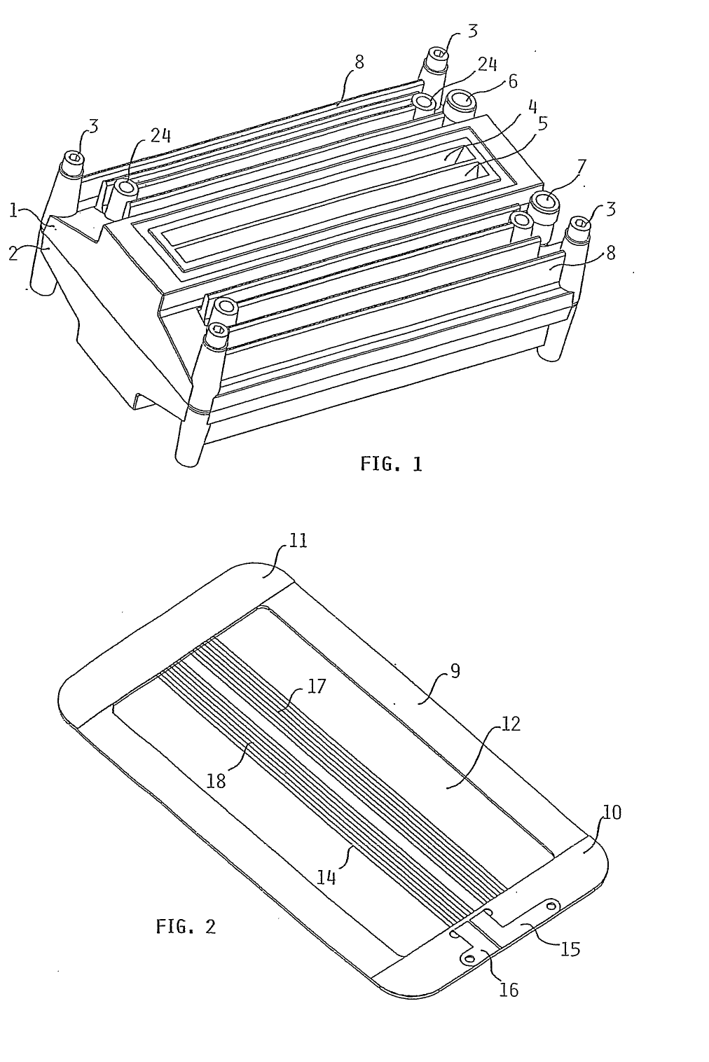

According to FIG. 1, a loudspeaker comprises a housing consisting of two substantially identical metal parts 1, 2, which are mounted together by means of screws 3. Each housing part 1, 2 has two elongate slot-shaped recesses or sound channels 4, 5, which enable the sound that is generated in the loudspeaker to propagate towards the outside. Furthermore, a housing part 1 is provided with electrical terminals 6, 7, to which the sound signal wires of an amplifier can be connected. The housing 1, 2 is provided with cooling fins 8 extending outwards and in the longitudinal direction, which function to dissipate the heat that is generated in the loudspeaker.

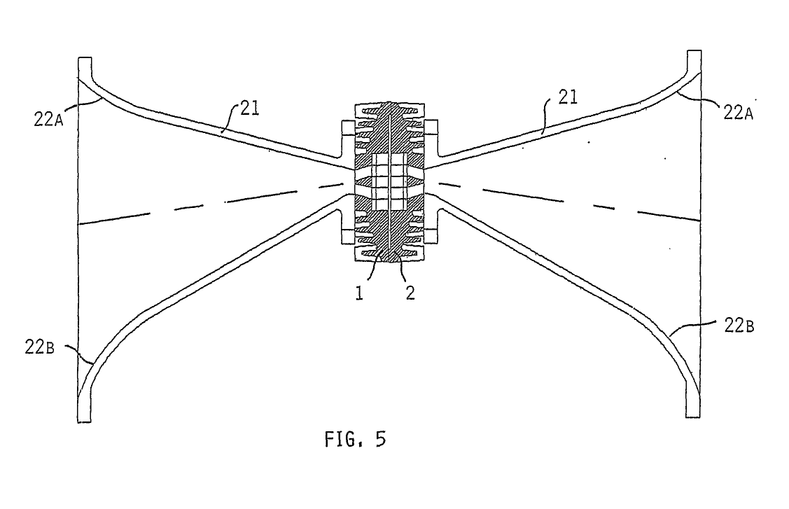

The housing parts 1, 2 enclose a frame that is shown in FIG. 2, which consists of a first frame-shaped frame member 9 and two strip-shaped frame members 10, 11 (shown in FIG. 4). The frame members 9, 10, 11 are preferably made of copper or anodised aluminium. The outer surface of the frame members 9, 10, 11 is in contact with the housing 1, 2 over the entire region thereof. A vibrating membrane 12 is affixed to the frame member 9 by means of a glue or by means of a thin, double-coated adhesive tape. The glue or the tape is of a heat-conducting type. An electrical conductor pattern 13 is arranged on the membrane 12, which conductor pattern is connected to the terminals 6, 7 and which causes the-membrane to vibrate when the amplifier transmits an electric signal to the loudspeaker.

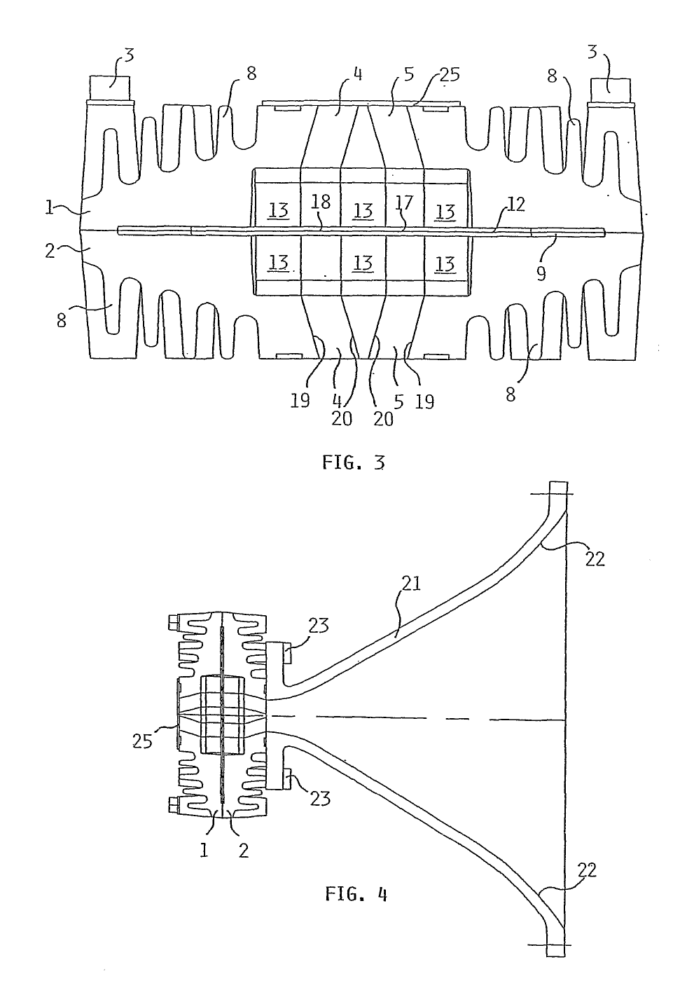

To that end the loudspeaker comprises magnets 13, as shown in FIG. 3, which generate a permanent magnetic field encompassing the conductor pattern 14 of the membrane 12. The conductor pattern 14 is formed by an electrically conducting wire, which is arranged in an elongate, rectangular spiral on one side of the membrane 12. At the short sides of the rectangular pattern, the frame members 10, 11 are mounted directly on the conductor pattern. Consequently, the glue or the tape by means of which said members are affixed to the conductive wire must be electrically insulating. On the other side of the membrane 12, said short sides of the pattern are likewise covered, in this case by the short sides of the frame-shaped frame member 9. This arrangement enables the conductor pattern 14 to transfer heat to the frame members 9, 10, 11 on both sides.

The two ends of the conducting wire are connected to power terminals 15, 16 on the frame member 10, which are in turn electrically connected to the terminals 6, 7. The power terminals 15, 16 are electrically insulated from the frame member 10. The lines of the conductor pattern 14 that extend parallel to each other in the longitudinal direction between the frame members 10, 11 form two spaced-apart vibrating regions 17, 18.

With reference now to FIG. 3, the sound channels 4, 5 extend from a position located near the two spaced-apart vibrating regions 17, 18 on the surface of the membrane 12 to the outer side of the housing parts 1, 2, on one side the sound channels 4, 5 are closed by a closing plate 25, however, because the loudspeaker must emit the sound in only one direction. The sound channels 4, 5 initially extend perpendicularly to the membrane, seen from the membrane, viz. in the area between the magnets 13, and subsequently the sound channels 4, 5 incline towards each other. Both the outer walls 19 and the inner walls 20 of each is sound channels 4, 5 extend obliquely towards each other, with the inner walls 19 and the outer wall 20 of a sound channel 4, 5 continuing to extend parallel to each other. On the outer side of the loudspeaker, only a very small spacing remains between the inner walls 19 of the two sound channels 4, 5, which spacing is at least several times smaller than the spacing between the vibrating regions 17, 18. In this way the fronts of the sound waves that are generated by the two vibrating regions 17, 18 are directed towards each other and combined, thus preventing disadvantageous interference between the two wavefronts.

FIG. 4 shows a sound horn 21, which is mounted in screw holes 24 of the loudspeaker by means of screws 23. The outer walls 19 of the sound channels 4, 5 join the walls 22 of the sound horn 21. The sound horn 21 effects a gradual widening of the sound front that emanates from the sound channels 4, 5 before it widens further into the environment. The horn, which is made of a metal, contributes to the heat dissipation of the loudspeaker.

According to FIG. 5, a loudspeaker comprises a loudspeaker 1, 2 as shown in the preceding Figures, in this case, however, a sound horn 21 is mounted to either side of the membrane. The closing plate 25 of FIGS. 3 and 4 has been replaced by a second sound horn 21, therefore. The figures do not show that the sound horns 21 have a rectangular cross-section. As FIG. 5 shows, the central axes of the sound horns 21, which are located between the upper wall 22a and the lower wall 22b, extend downwards at an angle from the membrane 12.

1. A loudspeaker comprising a magnet unit (13) that generates a magnetic field and a membrane (12) which is mounted in a frame (9, 10, 11) and which is provided with an electrical conductor arranged in a pattern (14) on the membrane (12), which membrane is positioned in the magnetic field in such a manner that a force is exerted when current is fed through the conductor pattern (14) on the membrane (12), which force is capable of setting the membrane (12) in motion so as to produce sound, said loudspeaker being provided with a sound opening (4, 5) located between the vibrating region (17, 18) and the outer side of the loudspeaker, which sound opening (4, 5) connects to a sound horn (21) having diverging walls, characterized in that substantially identical sound openings (4, 5) and sound horns (21) connecting thereto extend on both sides of the membrane.

2. A loudspeaker according to claim 1, wherein the membrane (12) is a flat membrane in which the conductor pattern (14) is integrated, and wherein the sound openings are formed by sound channels (4, 5).

3. A loudspeaker according to claim 1, wherein the sound horns (21) have an elongate, e.g. rectangular or oval cross-section.

4. A loudspeaker according to claim 1, wherein the central axes of the sound horns (21), which are located between the upper wall (22a) and the lower wall (22b), extend at an acute angle with respect to the membrane (12).

5. A loudspeaker according to claim 1, wherein the conductor pattern (14) is arranged on the membrane (12) in at least two spaced-apart vibrating regions (18, 18), wherein the loudspeaker is provided with at least two sound channels (4, 5), which extend between the two vibrating regions (17, 18) and the outer side of the housing (1, 2).

6. A loudspeaker according to claim 5, wherein the central axes of two sound channels (4, 5), which are located between the outer wall (19) and the inner wall (20) of each channel, incline towards each other over a particular distance from the membrane (12).

7. A loudspeaker according to claim 5, wherein the outer walls (19) of the two sound channels (4, 5) that are spaced furthest apart incline towards each other over at least a particular distance from the membrane (12).

8. A loudspeaker according to claim 5, wherein the inner walls (20) of the two sound channels (4, 5) that lie closest together incline towards each other over at least a particular distance from the membrane (12).

9. A loudspeaker according to claim 5, wherein the inner and outer walls (19, 20) of each sound channel (4, 5) extend substantially parallel to each other.

10. A loudspeaker according claim 5, wherein the outer walls (19) of the sound channels (4, 5) join the walls (22) of the sound horns (21) near their ends.

11. An assembly of loudspeakers, wherein a number of loudspeakers according to claim 1 are arranged in substantially aligned relationship, wherein the sound horns (21) of two adjacent loudspeakers are directed substantially towards each other, and wherein the facing surfaces of the membranes (12) of two adjacent loudspeakers are in phase.
